(19) United States
(12) Patent Application Publication
(10) Pub. No.: US 2005/0060360 A1
(43) Pub. Date: Mar. 17, 2005

(54) Method, system and program product for managing system resources

(75) Inventors: Ronald P. Doyle, Raleigh, NC (US); David L. Kaminsky, Chapel Hill, NC (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/662,772

(22) Filed: Sep. 15, 2003

(51) Int. Cl. G06F 15/16

(52) U.S. Cl. 709/200

(57) ABSTRACT

A method, system and program product for managing system resources. A resource is provisioned for a service based on a demand for the service and one or more attributes of the system. For example, provisioning a resource for the service can be based on the demand for the service as well as a demand for another service sharing the system. The provisioning can be based on any combination of various other attributes of the system along with or instead of the demand for another service.

### BACKGROUND OF THE INVENTION

1. Technical Field

The invention relates generally to system resources, and more specifically, to a method, system and program product for managing system resources.

2. Background Art

Electronic services such as ecommerce or other types of web sites, require one or more system resources in order to be provided to users. System resources include equipment such as a computer (e.g., server), a printer, a router, a storage system, etc. Further, system resources can comprise a portion of this equipment such as memory space, a subset of processors, processing time, communication bandwidth, etc. When a system is providing a service that is desired to be always available, system resources may periodically require “provisioning” while the service is being provided. In general, provisioning comprises loading and/or unloading software from one or more system resources. For example, a system may include two servers that provide a service, and one server may be temporarily removed from service for maintenance. Subsequent to the maintenance being performed, the server can be provisioned to again provide the service.

System resources may also be provisioned and/or re-provisioned based on a “demand” for the service. The demand comprises a measured load and/or an expected load for the service. For example, demand can be based on the number of users actually or anticipated to be using the service. Based on the demand, it can be determined whether the amount of resources provisioned for the service is sufficient to provide a desired response time and/or a target service level, allowing the amount of resources to be adjusted appropriately.

Current provisioning solutions implement sophisticated mechanisms to determine the demand for a service and to calculate the resources required to deliver a target service level. However, these solutions fail to consider other attributes of the system to determine how resources would be best provisioned. For example, when multiple services share a system, the demand for all the services may alter how the resources are best provisioned for a particular service.

As a result, a need exists for an improved method, system and program product for managing resources in a system. In particular, a need exists for a solution that provisions resources based on demand for a service and one or more other attributes of the system. For example, provisioning can be based on the demand for each service sharing resources of a system.

### SUMMARY OF THE INVENTION

The invention provides an improved method, system and program product for managing resources in a system. Specifically, under the invention, provisioning a resource for a service is based on one or more attributes of the system in addition to the demand for the service. Attributes of the system can comprise demand for one or more other services sharing the system, attributes of an image server used to provision the resources, attributes of one or more software servers that provide the service(s) to users, attributes of a network that provides communications between various resources of the system, relative amounts of time that the provisioning and/or demand will last, etc. As a result, the invention provides an improved solution for provisioning resources in a system.

A first aspect of the invention provides a method of managing resources in a system, the method comprising: determining a demand for a service; determining an attribute of the system; and provisioning a resource for the service based on the demand and the attribute.

A second aspect of the invention provides a method of managing resources in a system, the method comprising: determining a first demand for a service in the system; determining a set of attributes of the system, wherein the set of attributes comprises: a load on an image system, a load on a network used by the image system and a software server, and a second demand for at least one other service sharing the system; and provisioning a resource for the service based on the first demand and the set of attributes.

A third aspect of the invention provides a system for managing resources in a system, the system comprising: a demand system for determining a demand for a service; an attribute system for determining an attribute of the system; and a provisioning system for provisioning a resource for the service based on the demand and the attribute.

A fourth aspect of the invention provides a program product stored on a recordable medium for managing resources in a system, which when executed comprises: program code for determining a first demand for a service in the system; program code for determining a second demand for at least one other service sharing the system; and program code for provisioning a resource for the service based on the first demand and the second demand.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system for managing resources according to one embodiment of the invention;

FIG. 2 shows an alternative view of the system shown in FIG. 1; and

FIG. 3 shows another alternative view of the system shown in FIG. 1.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved method, system and program product for managing resources in a system. Specifically, under the invention, provisioning a resource for a service is based on one or more attributes of the system in addition to the demand for the service. Attributes of the system can comprise demand for one or more other services sharing the system, attributes of an image server used to provision the resources, attributes of one or more software servers that provide the service(s) to users, attributes of a network that provides communications between various resources of the system, relative amounts of time that the provisioning and/or demand will last, etc. As a result, the invention provides an improved solution for provisioning resources in a system.

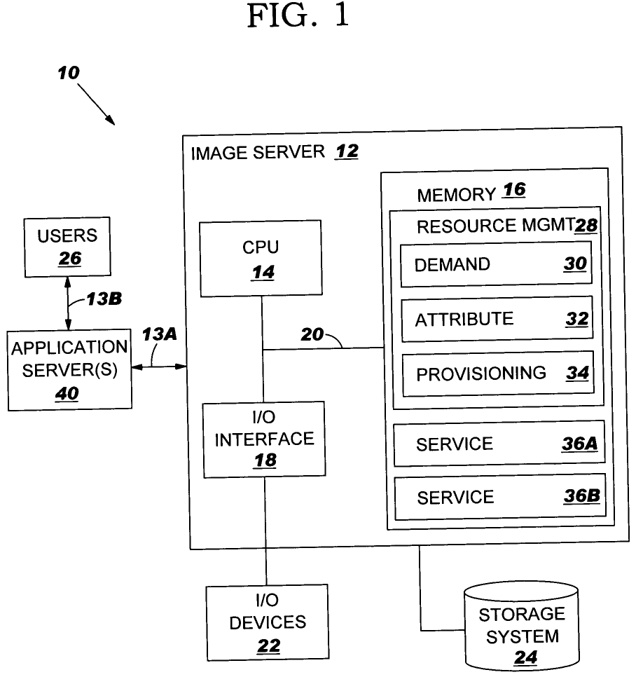

Turning to the drawings, FIG. 1 shows an illustrative system 10 for managing system resources. As depicted, image server 12 includes one or more services 36A-B that can be loaded onto one or more application servers 40. Subsequently, users 26 can access services 36A-B by communicating with application server(s) 40. Image server 12 communicates with application server(s) 40 via communications link 13A to load services 36A-B, and users 26 communicate with application server(s) 40 via communications link 13B to access services 36A-B. To this extent, communications links 13A-B can each comprise a direct hardwired connection (e.g., serial port), or another type of network connection. In the case of the latter, the network can comprise an addressable connection in a client-server (or server-server) environment that may utilize any combination of wireline and/or wireless transmission methods. In this instance, the server and client may utilize conventional network connectivity, such as Token Ring, Ethernet, WiFi or other conventional communications standards. Further, the network can comprise any type of network, including the Internet, a wide area network (WAN), a local area network (LAN), a virtual private network (VPN), etc. Where the client communicates with the server via the Internet, connectivity could be provided by conventional TCP/IP sockets-based protocol, and the client would utilize an Internet service provider to establish connectivity to the server.

As shown, image server 12 generally includes central processing unit (CPU) 14, memory 16, input/output (I/O) interface 18, bus 20, external I/O devices/resources 22, and a storage system 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage system 24 may comprise any type of data storage for providing more static storage of data used in the present invention. As such, storage system 24 may include one or more storage devices, such as a magnetic disk drive or an optical disk drive. Moreover, similar to CPU 14, memory 16 and/or storage system 24 may reside at a single physical location, comprising one or more types of data storage, or be distributed across a plurality of physical systems in various forms. Further, memory 16 and/or storage system 24 can include data distributed across, for example, a LAN, WAN or a storage area network (SAN) (not shown).

I/O interface 18 may comprise any system for exchanging information to/from an external device. I/O devices 22 may comprise any known type of external device, including speakers, a CRT, LED screen, handheld device, keyboard, mouse, voice recognition system, speech output system, printer, monitor/display, facsimile, pager, etc. Bus 20 provides a communication link between each of the components in image server 12 and likewise may comprise any known type of transmission link, including electrical, optical, wireless, etc. In addition, although not shown, additional components, such as cache memory, communication systems, system software, etc., may be incorporated into image server 12.

Further, application server(s) 40 typically include the same elements as shown in image server 12 (e.g., CPU, memory, I/O interface, etc.). These have not been separately shown and discussed for brevity. It is also understood that users 26 could use computing devices (not shown) to communicate with application server(s) 40. These computing devices, along with image server 12 and application server(s) 40, comprise any type of computing devices capable of communicating with one or more other computing devices. For example, the computing devices could comprise any combination of a server, a client, a desktop computer, a laptop, a handheld device, a mobile phone, a pager, a personal data assistant, etc. It is understood, however, that if a computing device is a handheld device or the like, a display could be contained within the computing device, and not as an external I/O device 22 as shown for image server 12.

Shown stored in memory 16 is a resource management system 28 that manages resources in system 10. Resource management system 28 is shown including a demand system 30, an attribute system 32, and a provisioning system 34. In general, demand system 30 determines a demand for a particular service 36A-B and attribute system 32 determines one or more attributes of system 10. Based on the determined demand and one or more attributes (e.g., a set of attributes), provisioning system 34 provisions one or more resources for the particular service 36A-B.

It is understood that throughout this discussion “provisioning” includes loading software, unloading software, reserving resources, reserving portions of resources, etc. for a particular service. Further, the terms “provisioning” and “re-provisioning” are used interchangeably. As a result, “provisioning” includes “re-provisioning” and vice versa. Similarly, “demand” includes an expected demand, a current demand, and/or a previous demand for a particular service. Further, it is understood that “resources” of system 10 include, for example, image server 12, application server(s) 40, storage system 24, communications link 13A, or portions of any of the various components of system 10. In the case of the latter, a resource may comprise, for example, a portion of memory 16 in an application server 40, a portion of storage area on storage system 24, one or more CPUs 14 or processing time reserved on CPU 14 in an application server 40, communication bandwidth on communications link 13A, etc. Still further, it is understood that while the discussion herein is limited to application servers 40, any software server can be provisioned. For example, a software server such as a web server, a database server, a transaction server, etc. can be provisioned in the same manner as application servers 40.

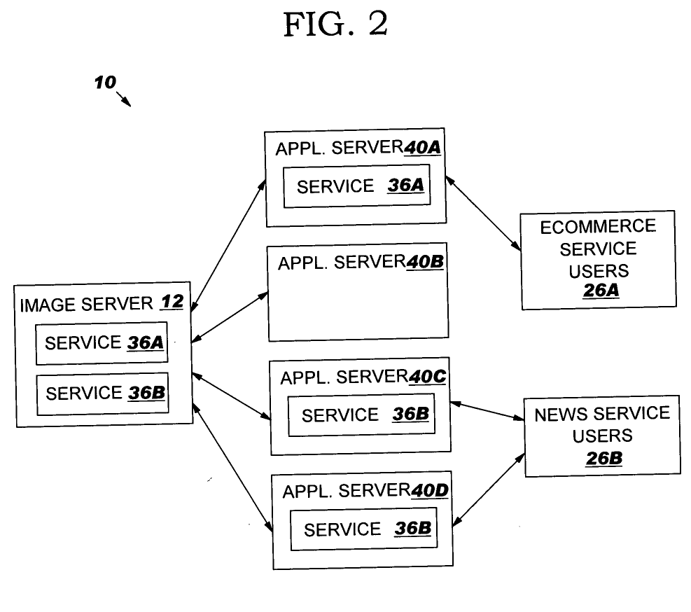

FIG. 2 shows an alternative view of the illustrative system 10 shown in FIG. 1. As shown, image server 12 includes two services 36A-B that can be accessed by users 26A-B. For example, service 36A can comprise an ecommerce service that is used by users 26A, and service 36B can comprise a news service that is used by users 26B. In one embodiment, resources of system 10 comprise application servers 40A-D. Each application server 40A-D can be provisioned for either service 36A-B. Image server 12 provisions one or more of four application servers 40A-D for a service 36A-B based on a demand for each service 36A-B and one or more attributes of system 10. As shown, the demand for service 36B may be greater than the demand for service 36A. As a result, service 36A is shown loaded onto a single application server 40A, while service 36B is shown loaded onto two application servers 40C-D. Application server 40B is not shown having either service 36A-B. This may be due to application server 40B undergoing maintenance, a low enough demand that application server 40B is not required, etc.

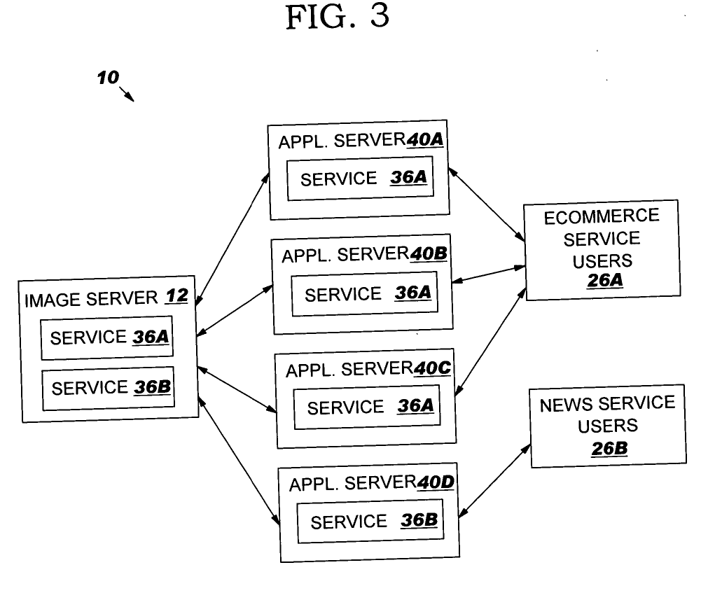

FIG. 3 shows another alternative view of the illustrative system 10 shown in FIGS. 1 and 2 after application servers 40B-C have been re-provisioned for service 36A. In order to provision one or more application servers 40A-D for service 36A, the demand for both services 36A-B can be considered. For example, the configuration shown in FIG. 3 may be the result of an increased demand for service 36A (e.g., an ecommerce service) along with a decreased demand for service 36B (e.g., a news service) when compared to the configuration shown in FIG. 2. As a result, application servers 40A-C have been provisioned to service 36A, while only application server 40D is provisioned for service 36B.

In order to obtain the configuration shown in FIG. 3 from the configuration shown in FIG. 2, demand system 30 (FIG. 1) can determine that a demand for service 36A requires additional resources (e.g., application servers 40A-D) to obtain, for example, a desired response time for users 26A. Attribute system 32 (FIG. 1) can determine that a demand for service 36B is sufficiently low that some of its resources can be made available to service 36A. Based on the determined demands for services 36A-B, provisioning system 34 (FIG. 1) can provision additional resources (e.g., application servers 40B-C) for service 36A, and remove some resources (e.g., application server 40C) from service 36B. It is understood that numerous variations are possible. For example, if the demand for service 36B was approximately the same as that for service 36A, each service 36A-B could be provisioned two application servers 40A-D.

Other attributes of system 10 can be determined in addition to or alternative to the demand for one or more other services when provisioning resources for a particular service. For example, a software status of one or more of application servers 40A-D can be determined by attribute system 32 (FIG. 1). Software status can comprise the state and/or type of software currently on a particular application server 40A-D. For example, software that is frequently being used by users 26A-B may be more difficult to remove than if the software is infrequently being used. Similarly, each application server 40A-D may be capable of executing on one of multiple operating systems. In this case, it would be more efficient to provision an application server 40A-D that currently has the correct operating system for a service 36A-B than it would be to provision an application server 40A-D that would require a new operating system to be loaded.

A cache state of one or more application servers 40A-D may also be determined by attribute system 32 (FIG. 1). For example, application servers 40A-D may be providing several services 36A-B, some of which are more closely related than others (e.g., same operating system, some shared code, etc.). As a result, when provisioning all or a portion of an application server 40A-B for a particular service 36A-B, it may be more efficient to select an application server 40A-D that currently and/or recently has provided a similar service 36A-B in order to potentially benefit from some of the data already in the cache of the application server 40A-D.

An amount of time that will be required to provision a resource and/or an amount of time that the demand for a service should last may also be determined by attribute system 32 (FIG. 1). For example, an increased demand for a service may be expected to last for only a short period, and provisioning a particular resource may require most of the period. As a result, it may be more efficient not to provision the resource, or select a different resource to provision in order to meet the temporary increase in demand. Further, if multiple resources could be provisioned to meet the demand for a particular service 36A-B, the resource that can be provisioned in less time may be provisioned for the service 36A-B.

A load on image server 12 can also be determined by attribute system 32 (FIG. 1). For example, it may be desired to provision additional resources for service 36A. However, image server 12 may currently be provisioning resources for service 36B, which requires a significant amount of processing and/or communications by image server 12. In this case, if image server 12 were to start provisioning for service 36A, the provisioning for both services 36A-B may be slowed undesirably. As a result, provisioning for service 36A can be delayed until the load on image server 12 is lower. Similarly, a load on communications link 13A (FIG. 1) can be considered. For example, a second image server (not shown) may be provisioning resources that is currently generating a large amount of communications over communications link 13A (e.g., a network). Rather than adding additional traffic on the network thereby slowing all communications, provisioning resources for another service 36A-B can be postponed until the communications load occurring on the network is less.

In any event, provisioning system 34 (FIG. 1) can use any solution for determining the relative importance of the demand for a service 36A-B and the attribute(s) of the system 10 in order to determine how/if resources will be provisioned for the service 36A-B. For example, when multiple services 36A-B share the resources of system 10, attribute system 32 (FIG. 1) can determine an overall demand for all services 36A-B sharing system 10. Provisioning system 34 can then provision a resource for a particular service 36A-B by approximating the percentage of the overall demand attributable to the particular service 36A-B.

It is understood that the invention is not limited to systems 10 having two services 36A-B. When additional services are present, attribute system 32 (FIG. 1) can determine a collective demand for all services 36A-B other than a particular service being provisioned. The collective demand and the demand for the service being provisioned can be used to provision resource(s) of the system appropriately. Additionally, the demand for each service 36A-B can be considered to determine if a resource currently provisioned for a service can be re-provisioned for another service. Alternatively, if only a single service is present in a system, the attributes considered can comprise the various other attributes of system 10, as discussed above.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of managing resources in a system, the method comprising:
determining a demand for a service;
determining an attribute of the system; and
provisioning a resource for the service based on the demand and the attribute.

2. The method of claim 1, wherein the attribute comprises a demand for at least one other service sharing the resources.

3. The method of claim 1, wherein the resources comprise at least one software server, and wherein the attribute comprises a software status of the at least one software server.

4. The method of claim 1, wherein the resources comprise at least one software server, and wherein the attribute comprises a cache state of the at least one software server.

5. The method of claim 1, wherein the attribute comprises a time period required to provision at least one of the resources for the service.

6. The method of claim 1, wherein the attribute comprises a load on the image system.

7. A method of managing resources in a system, the method comprising:
determining a first demand for a service in the system;
determining a set of attributes of the system, wherein the set of attributes comprises: a load on an image system, a load on a network used by the image system and an software server, and a second demand for at least one other service sharing the system; and
provisioning a resource for the service based on the first demand and the set of attributes.

8. The method of claim 7, further comprising determining a time period for the first demand, wherein the provisioning is further based on the time period.

9. The method of claim 7, wherein the set of attributes further comprises at least one of: a software status, a cache state, and a load on the software server.

10. The method of claim 7, wherein the set of attributes further comprises a time period required to provision a resource for the service.

11. A system for managing resources in a system, the system comprising:
a demand system for determining a demand for a service;
an attribute system for determining an attribute of the system; and
a provisioning system for provisioning a resource for the service based on the demand and the attribute.

12. The system of claim 11, wherein the resources comprise a plurality of software servers for hosting the service.

13. The system of claim 12, wherein the attribute comprises at least one of: a software state, a cache state, and a load on at least one of the plurality of software servers.

14. The system of claim 11, wherein the system further comprises an image server for provisioning resources for the service.

15. The system of claim 14, wherein the attribute comprises a load on the image server.

16. The system of claim 11, wherein the attribute comprises a demand for at least one other service sharing the resources.

17. A program product stored on a recordable medium for managing resources in a system, which when executed comprises:
program code for determining a first demand for a service in the system;
program code for determining a second demand for at least one other service sharing the system; and
program code for provisioning a resource for the service based on the first demand and the second demand.

18. The program product of claim 17, further comprising program code for determining an attribute of at least one resource in the system.

19. The program product of claim 17, further comprising program code for determining an attribute of a network for the resources.

20. The program product of claim 17, further comprising program code for determining an attribute of an image server.
